(19) United States
(12) Patent Application Publication
(10) Pub. No.: US 2018/0131058 A1
(43) Pub. Date: May 10, 2018

(54) BATTERY PACK AND POWER TOOL

(71) Applicant: Nanjing Chervon Industry Co., Ltd., Nanjing (CN)

(72) Inventors: Zhuo Wang, Nanjing (CN); Dongrong Qiu, Nanjing (CN); Weipeng Chen, Nanjing (CN)

(21) Appl. No.: 15/801,989

(22) Filed: Nov. 2, 2017

(30) Foreign Application Priority Data
Nov. 7, 2016 (CN) 201610976746.5

(51) Int. Cl. H01M 10/6563; H01M 2/10; H01M 10/613; H01M 10/6235; H01M 10/6556

(52) U.S. Cl. CPC H01M 10/6563; H01M 2/1005; H01M 2/1022; B24B 23/028; H01M 10/6235; H01M 10/6556; H01M 2220/30; H01M 10/613

(57) ABSTRACT

A battery pack includes a plurality of cells, a housing for containing the cells, and a pair of brackets for supporting the cells. Each cell includes a cell body for storing a chemical substance that is capable of generating electric energy and a pair of cell electrodes allowing the cell to input or output the electric energy. A sealant is filled between the brackets and the housing so that the cell electrodes are sealed in a sealed space constituted by the brackets, the housing and the sealant, the cell body is partially located outside the sealed space. The housing is formed with an air inlet and an air outlet so that an airflow through the air inlet and the air outlet can flow through a part of the cells which is located outside the sealed space.

### RELATED APPLICATION INFORMATION

This application claims the benefit under 35 U.S.C. § 119(a) of Chinese Patent Application No. CN201610976746.5, filed on Nov. 7, 2016, the disclosure of which is incorporated herein by reference in its entirety.

### FIELD OF THE DISCLOSURE

The present disclosure relates generally to battery packs and power tools and, more particularly, to a cooling technique for use with a battery pack and a power tool.

### BACKGROUND OF THE DISCLOSURE

Most currently known power tools use battery packs as a power source. The battery pack and the power tool can generate heat during work. High temperatures, if generated, can affect the usability of the battery pack and the power tool and a security problem may be caused when the battery pack and/or tool is in a bad condition. Accordingly, cooling of the battery pack and the power tool should be considered during the design of the battery pack and the power tool.

The statements in this section merely provide background information related to the present disclosure and may not constitute prior art.

### SUMMARY

In one aspect of the disclosure, a battery pack includes a plurality of cells, a housing for containing the cells, and a pair of brackets for supporting the cells. Each cell includes a cell body for storing a chemical substance that is capable of generating electric energy and a pair of cell electrodes allowing the cell to input or output the electric energy. A sealant is filled between the brackets and the housing so that the cell electrodes are sealed in a sealed space constituted by the brackets, the housing and the sealant, and the cell body is partially located outside the sealed space. The housing is formed with an air inlet and an air outlet so that an airflow through the air inlet and the air outlet can flow through a part of the cells which is located outside the sealed space.

In another aspect of the disclosure, a power tool includes a tool main body including a tool attachment for realizing a function of a tool and a main motor for driving the tool attachment, a battery pack including a housing and a plurality of cells contained in the housing, and a backpack device for wearing on a human body. The tool main body is connected with the backpack device. The battery pack is coupled detachably with the backpack device. The housing of the battery pack is formed with an air inlet and an air outlet. The backpack device includes a device air channel, the device air channel is operable to communicate with the air outlet of the battery pack to cool the cells of the battery pack when the battery pack is coupled with the backpack device.

In another aspect of the disclosure, a power tool includes a tool main body including a tool attachment for realizing a function of a tool and a main motor for driving the tool attachment, and a battery pack including a housing and a plurality of cells contained in the housing. The housing includes an air outlet. The tool main body includes a first fan for generating an airflow and a tool air channel which is capable of communicating the air outlet of the battery pack and the first fan when the battery pack is coupled with the tool main body, so that heat from the battery pack can flow in the tool air channel to dissipate heat under the action of the first fan.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of an exemplary battery pack.

FIG. 2 is a schematic view showing the structure of the battery pack in FIG. 1.

FIG. 3 is an exploded view of the battery pack in FIG. 1.

FIG. 4 is a sectional view of the battery pack in FIG. 1.

FIG. 5 is a schematic view showing the flowing direction of the airflow of the battery pack in FIG. 1.

FIG. 6 is a schematic view of an example tool in the form an angle grinder.

FIG. 7 is a schematic view showing the inner structure of the angle grinder in FIG. 6.

FIG. 8 is an exploded view of the angle grinder in FIG. 6.

FIG. 9 is a schematic view showing the flowing direction of the airflow of the angle grinder in FIG. 6.

FIG. 10 is a schematic view of a further angle grinder.

FIG. 11 is a schematic view showing the inner structure of the angle grinder in FIG. 10.

FIG. 12 is a schematic view showing the flowing direction of the airflow of the angle grinder in FIG. 10.

FIG. 13 is a schematic view of an example tool in the form of an electric drill.

FIG. 14 is a schematic view showing the inner structure of the electric drill in FIG. 13.

FIG. 15 is another schematic view showing the inner structure of the electric drill in FIG. 13.

FIG. 16 is an exploded view of the electric drill in FIG. 13.

FIG. 17 is a schematic view showing the flowing direction of the airflow of the electric drill in FIG. 13.

FIG. 18 is a schematic view of an example tool in the form of a blower.

FIG. 19 is a schematic view showing the structure of a battery pack in FIG. 18.

FIG. 20 is another schematic view showing the structure of the battery pack in FIG. 18.

FIG. 21 is an exploded view of the blower in FIG. 18.

FIG. 22 is another exploded view of the blower in FIG. 18.

The drawings described herein are for illustrative purposes only of selected examples and not all possible examples and implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the invention hereinafter claimed, its application, or uses.

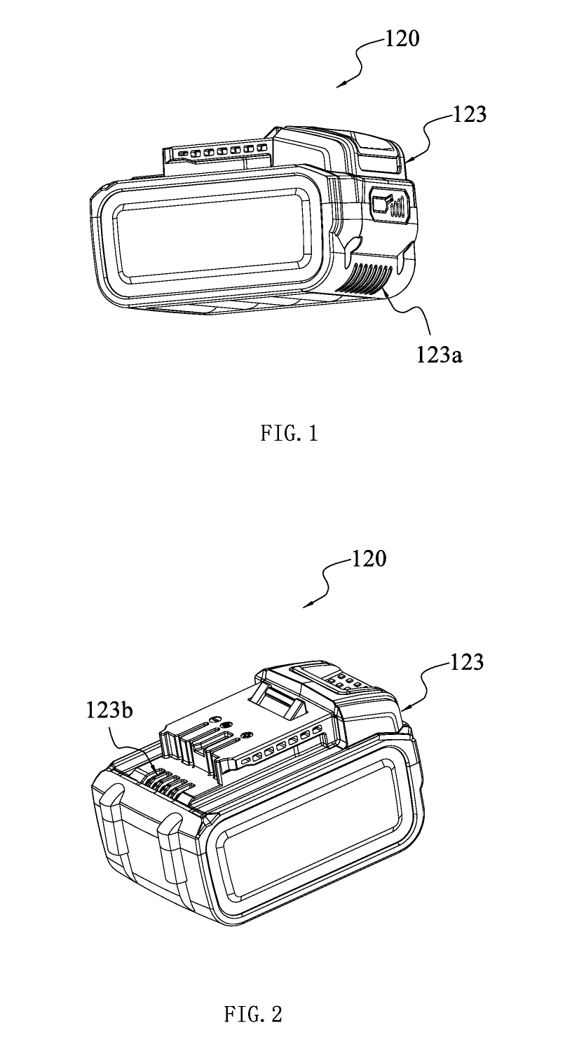

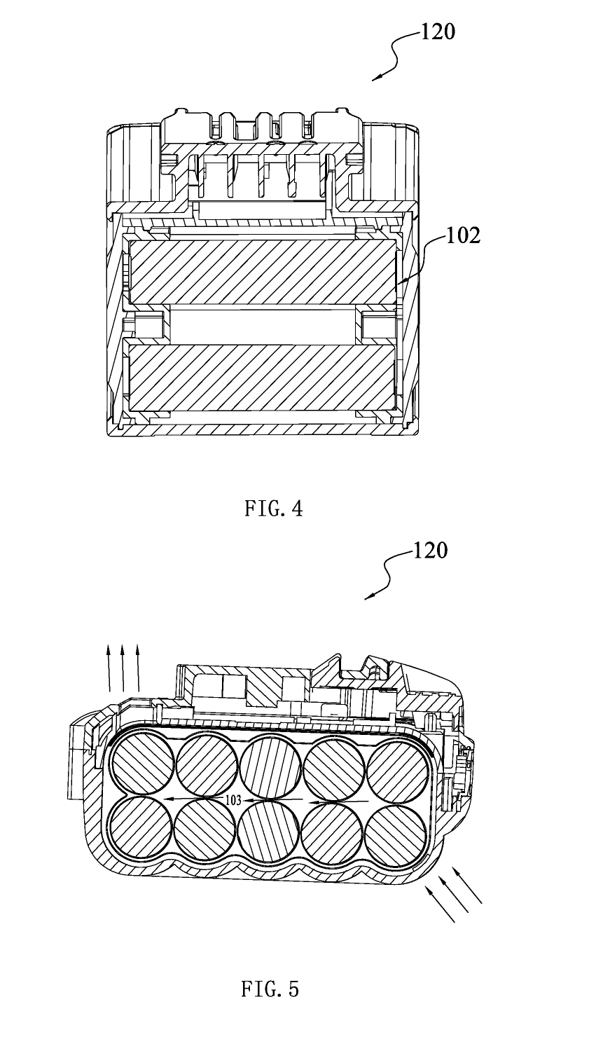

Referring to FIGS. 1-5, a battery pack 120 can be coupled detachably to a power tool for suppling power to the power tool. The battery pack 120 includes a plurality of cells 121. Each cell 121 includes a cell body 121a for storing a chemical substance which can generate electric energy and a pair of cell electrodes 121b allowing the cell 121 to output or input electric energy. Specifically, the cell body 121a is a generally cylindrical body taking a central axis 101 as an axis. The length direction of the cell body 121a is substantially parallel to the central axis 101. The plurality of cells 121 are arranged substantially parallel to each other. The two cell electrodes 121b are disposed on two ends of the cell body 121a in a direction of the central axis 101. Gaps 121c are formed between the plurality of cells 121.

The battery pack 120 further includes a housing 123 for containing the cells 121 and a pair of brackets 124 for supporting the cells 121. The two brackets 124 are disposed on the two ends of the cell body 121a in the direction of the central axis 101.

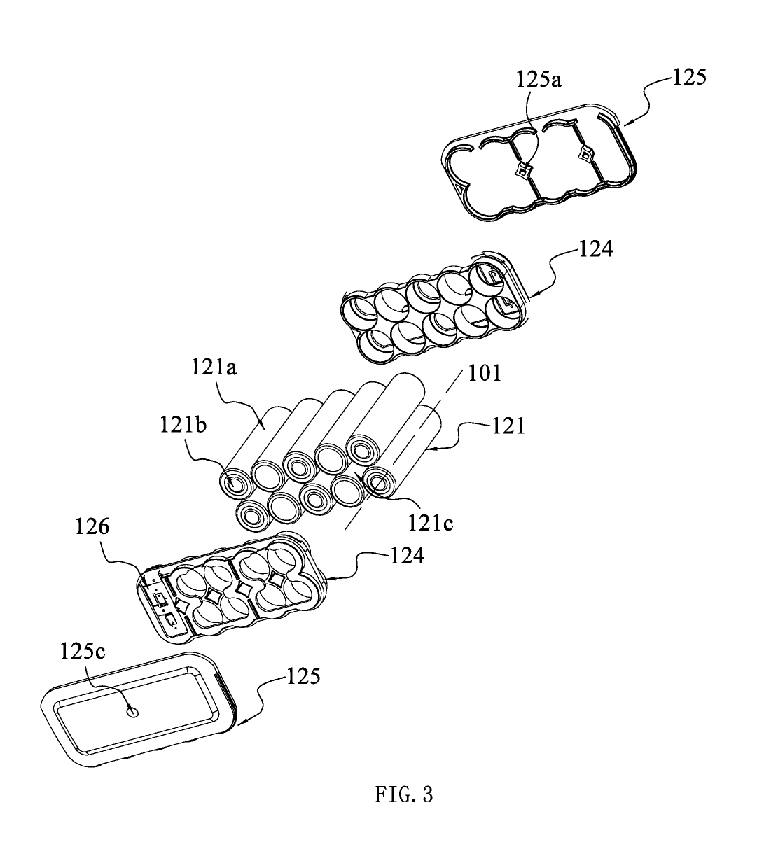

Referring to FIGS. 3-5, a sealant is filled between each bracket 124 and the housing 123, so that the cell electrode 121b is enclosed in a sealed space 102 constituted by the bracket 124, the housing 123 and the sealant. The cell body 121a is partially located outside the sealed space 102. It is noted that, the sealant here can be a sealing gum or a sealing element with a sealing property, for example a gasket, which is disposed between the bracket 124 and the housing 123 and can constitute the sealed space 102 together with the bracket 124 and the housing 123.

The housing 123 includes a cover 125 disposed on an end of the cells 121 in the direction of the central axis 101. The cover 125 and the bracket 124 constitute the sealing space. Specifically, the electrode 121b includes a positive electrode and a negative electrode. Two covers 125 are respectively disposed on two ends of the positive electrode and the negative electrode along the central axis 101. The sealant is filled between each cover 125 and each bracket 124, so that the electrode 121b is enclosed in the sealing space 102 constituted by the cover 125, the bracket 124 and the sealant.

The battery pack 120 further includes a plurality of connecting pieces 126 for connecting the cells 121 in series or in parallel. A part of the connecting pieces 126 are disposed in the sealing space 102. Through arranging the electrodes 121b and a part of the connecting pieces 126 in the sealing space 102 constituted by the covers 125, the brackets 124 and the sealant, it is made difficult for outside dust and water to access the electrodes 121b. Thereby, the risk of short circuit of the electrodes 121b is reduced, and the assembling of the battery pack 120 is facilitated while the dustproof and the waterproof aspects of the battery pack 120 are improved efficiently.

The cover 125 is formed with several air holes 125a which are communicated with the gaps 121c between the cell bodies 121a. The gaps 121c and the air holes 125a form an air channel allowing the convection with the external air so as to facilitate the cooling of the cells 121. Specifically, a dust screen can be disposed on the air holes 125a in order to prevent dust from entering.

The housing 123 is formed with an air inlet 123a and an air outlet 123b which allow the airflow to flow through the part of the cell bodies 121a outside the sealing space 102. Referring to FIGS. 3 and 5, the cell bodies 121a are cylinders approximately. The airflow, which flows in through the air inlet 123a and flows out through the air outlet 123b, is substantially perpendicular to the cell bodies 121a. The chemical substance in the cell bodies 121a can react and generate heat during charge and discharge. In the housing 123 of the battery pack 120, the air channel, which allows the airflow to flow, is formed between the external surfaces of the cell bodies 121a and the brackets 124. The cool air outside can flow into the housing 123 through the air inlet 123a, and then flow over the external surfaces of the cell bodies 121a along the arrow 103 in FIG. 5, and finally flow out through the air outlet 123b so as to take away the heat of the cell bodies 121a and cool the battery pack 120.

In order to enhance the cooling effect of the battery pack 120, a fan for generating airflow can be disposed between the air inlet 123a and the air outlet 123b. A motor for driving the fan can be disposed within the housing 123 of the battery pack 120.

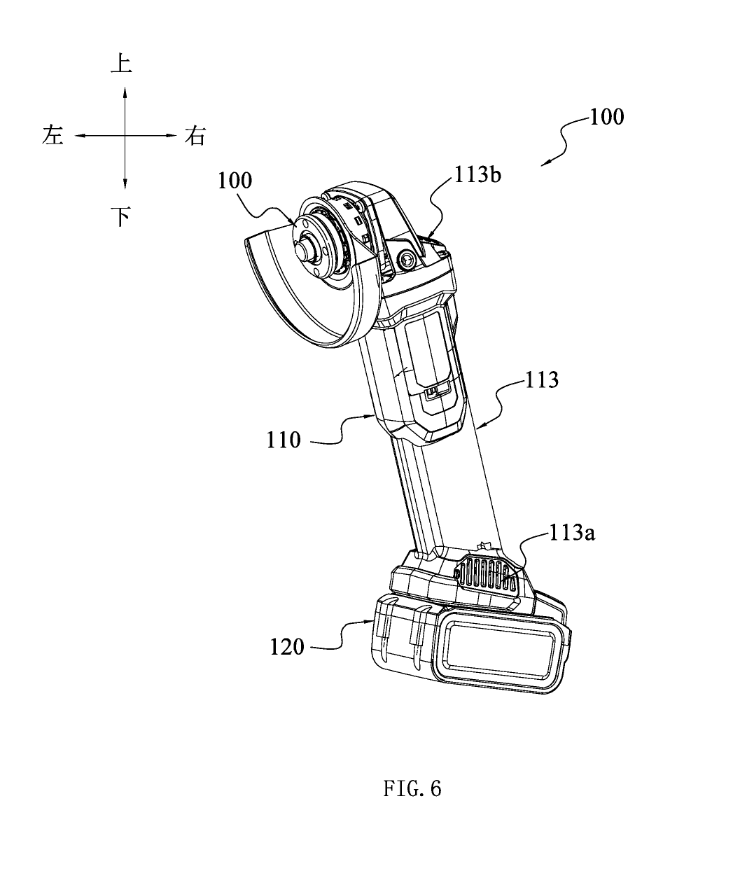

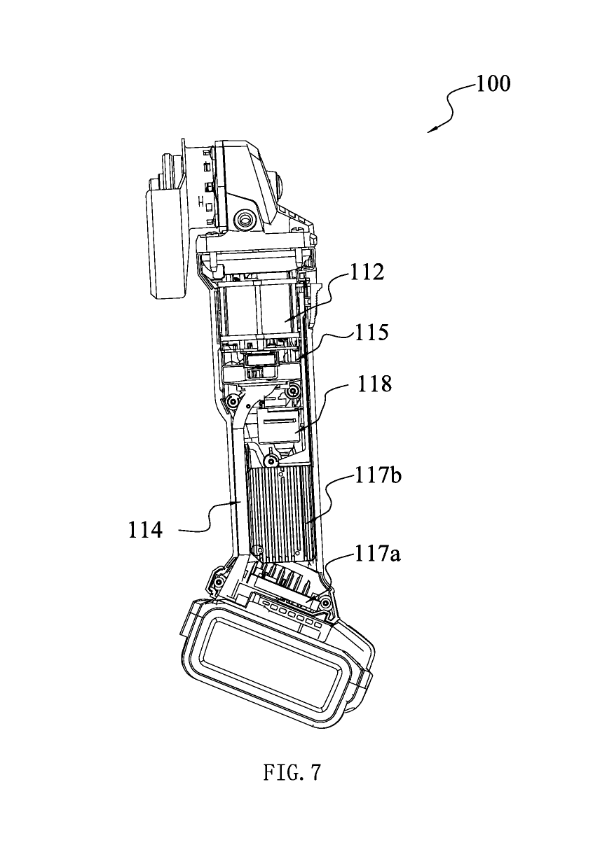

Referring to FIGS. 6-9, an angle grinder 100 includes a tool main body 110 and the battery pack 120 is coupled to the tool main body 110 detachably. The battery pack 120 may use the embodiment described above or other battery pack which can be coupled with the angle grinder 100 and supply power to the angle grinder 100.

The tool main body 110 includes a tool attachment for realizing a tool function and a main motor 112 for driving the tool attachment. In this example, a grinding disc 111 acts as the tool attachment and the grinding disc 111 realizes a grinding function when it is driven by the main motor 112.

Referring to FIGS. 6-8, the tool main body 110 includes the grinding disc 111 acting as the tool attachment, the main motor 112, a tool housing 113, a tool air channel 114, a first fan 115 and a second fan 116. For illustrating clearly, the up and down direction and the left and right direction hereinafter refers to the directions in FIG. 6.

The tool housing 113 includes a tool air inlet 113a allowing the airflow to enter and a tool air outlet 113b allowing the airflow to exit. Specifically, the tool air inlet 113a is disposed on an end of the tool housing 113 that is close to the battery pack 20, and the tool air outlet 113b is disposed on another end of the tool housing 113 that is close to the grinding disc 111. More specifically, the tool air outlet 113b is located between the second fan 116 and the grinding disc 111.

The main motor 112 disposed in the tool housing 113 is used to drive the grinding disc 111 to rotate so as to realize the grinding function of the angle grinder 100. Specifically, the main motor 112 is a brushless motor, which is located in the tool housing 113 and close to the grinding disc 111.

The second fan 116 for exhausting the airflow from the tool housing 113 is disposed between the main motor 112 and the grinding disc 111. The second fan 116 is coaxial with the main motor 112 and rotated synchronously with the main motor 112. It can be comprehended that the second fan 116 can be a part of the main motor 112.

The first fan 115 for generating airflow is disposed between the tool air channel 114 and the main motor 112. The first fan 115 is coaxial with the main motor 112 and rotated synchronously with the main motor 112. Specifically, the first fan 115 is disposed on the upper end of the tool air channel 114 so as to generate the airflow to accelerate the hot airflow from the battery pack 120 to flow along the direction of the arrow 105. More specifically, the first fan 115 is a centrifugal fan.

The tool air channel 114 disposed in the tool housing 113 is able to communicate the air outlet 123b of the battery pack 120 and the first fan 115 when the battery pack 120 is coupled with the tool main body 110. Specifically, the tool air channel 114 is disposed on the left side of the tool housing 113.The tool air channel 114 includes an upper end and a lower end, both of which are openings with large cross-sectional area. The tool air channel 114 also includes a middle section which has a straight type with small cross-sectional area. With this arrangement, in one aspect, the tool air channel 114 can increase the airflow flowing in and out; in another aspect, the tool air channel 114 can accelerate the airflow so as to improve the cooling efficiency of the angle grinder. Meanwhile, the arrangement of the tool air channel 114 can provide enough space to place a circuit board 117b for driving the main motor 112 and a switch 118 for controlling the angle grinder 100.

The battery pack 120 is coupled with the tool main body 110. When the switch 118 is turned on, the battery pack 120 supplies power to the tool main body 110 so that the angle grinder 100 can be used to grind a workpiece. The battery pack 120 can generate heat during working, and the electronic elements on the circuit board 117b and the main motor 112 can generate heat as well. In order to avoid the security problem caused by a temperature rise in the battery pack 120 and the tool main body 110 due to any overheating, it is needed to speed up the heat dissipating of the battery pack 120 and the tool main body 110.

As shown in FIG. 6, the tool air inlet 113a is disposed on the front side of the tool housing 113 which is corresponded with a circuit board 117a for connecting with the terminals of the battery pack 120 electrically. This arrangement can ensure the cooling area and cooling efficiency of the circuit board 117a as soon as possible.

The outside air can flow into the tool housing 113 through the tool air inlet 113a, and then flow through the circuit boards 117a, 117b and the main motor 112 successively along the arrow 104, and finally flow out of the tool housing 113 through the tool air outlet 113b under the action of the second fan 116. Thereby, the heat generated by the circuit boards 117a, 117b and the main motor 112 is taken away and the tool main body 120 is cooled.

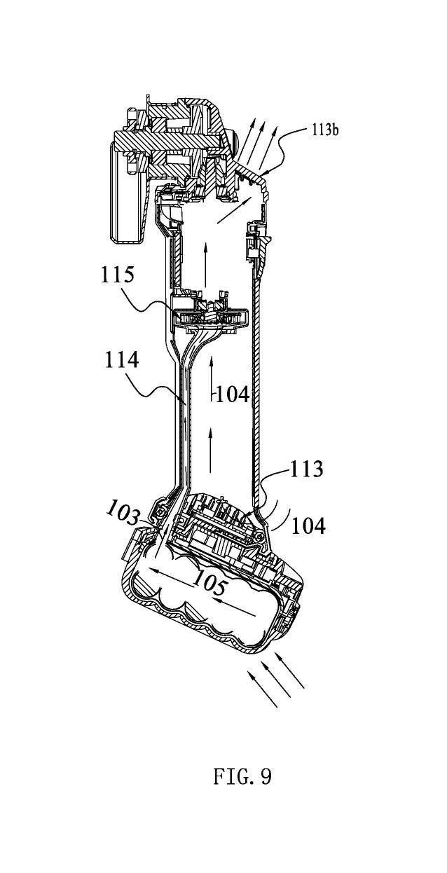

As shown in FIG. 9, the main motor 112 is able to drive the first fan 115 to rotate. The outside air can enter the battery pack 120 through the air inlet 123a and flow in the battery pack 120 along the arrow 103 by means of the rotation of the first fan 115, and then flow out of the battery pack 120 through the air outlet 123b and flow in the tool air channel 114 along the arrow 104, and finally exhaust from the tool housing 113 under the action of the second fan 116.

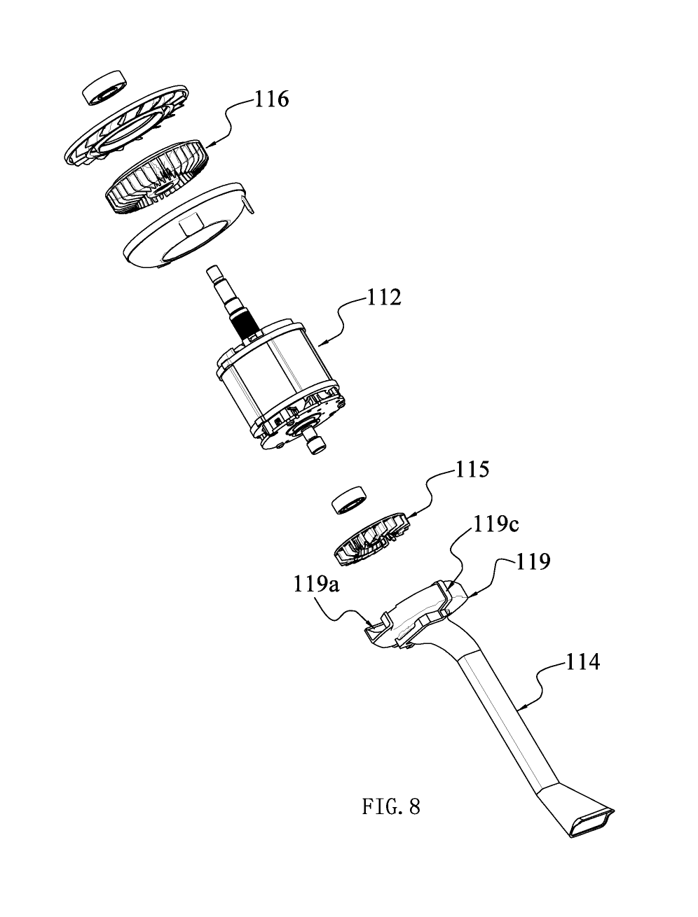

As shown in FIG. 8, the angle grinder 100 further includes an air guide cover 119. The air guide cover 119 is provided with a containing recess for containing the first fan 115. That is, the air guide cover 119 is arranged on the periphery of the first fan 115. An end of the air guide cover 119 is connected with an opening on the upper end of the tool air channel 114. The air guide cover 119 is provided with two cover air outlets 119a in its radial direction for guiding the airflow. So, the airflow along the arrow 104 in the tool air channel 114 can exhaust through the cover air outlets 119a by means of the guide of the air guide cover 119 under the action of the first fan 115.

The air guide cover 119 includes two fixing elements 119c disposed on the left side and right side, so that the air guide cover 119 can be fixed to the tool housing 113 and the other airflow in the tool housing 113 can flow freely. Here, the other airflow means the airflow which is not from the battery pack 120.

Considering the assembling requirement, the air guide cover 119 is divided into two guide portions. One guide portion is integral with the tool air channel, and the other guide portion can be connected with the one guide portion through a fastener or other fixing methods so as to constitute the containing recess for containing the first fan 115 cooperatively.

In order to facilitate the airflow to exhaust from the tool housing 113, the tool housing 113 is formed with two housing air outlets which are corresponded with the cover air outlets 119a respectively. So, the main motor 112 can drive the first fan 115 to rotate, and the airflow can flow into the battery pack 120 through the air inlet 123a and flow through the cells along the arrow 105 under the action of the first fan 115, so that the heat in the battery pack can be taken away. Then the airflow can flow out of the battery pack 120, and then enter the tool air channel 114 and flow along the arrow 104, and finally flow out of the tool housing 113 through the cover air outlets 119a and the housing air outlets and the heat dissipating can be realized.

With the example described above, the airflow from the battery pack 120 and the airflow in the tool main body 110 are separated, so that the heat generated by the battery pack 120 can flow out of the tool housing 113 directly through the tool air channel 114 under the action of the first fan 115. This arrangement can avoid the heat generated by the battery pack 120 from affecting the circuit board and other elements in the tool housing 113 while speeding up the heat dissipating of the angle grinder 100.

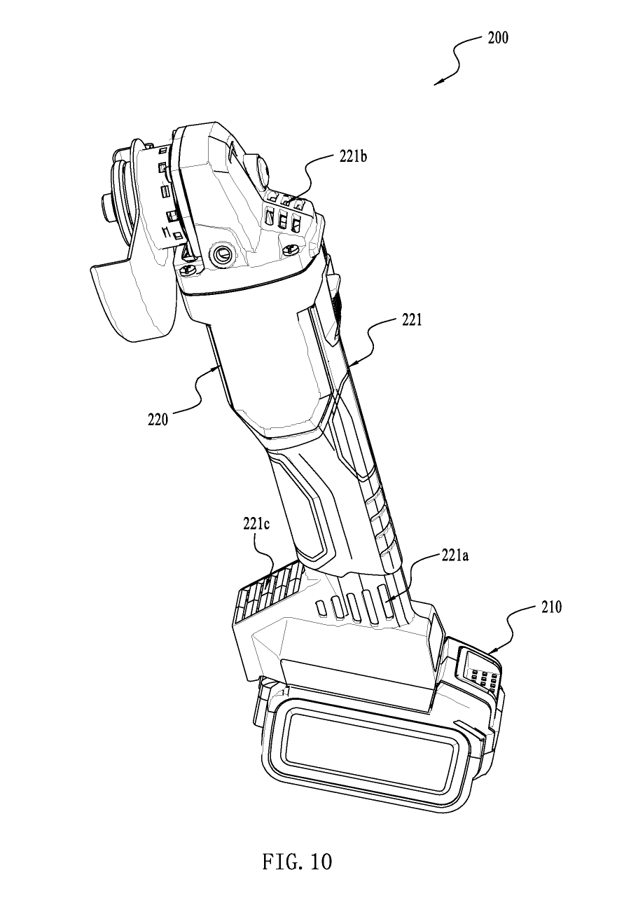

Referring to FIGS. 10-12, an angle grinder 200 includes a battery pack 210 and a tool main body 220. The battery pack 210 is coupled detachably with the tool main body 220. Specifically, the battery pack 210 can be the same as the battery pack 110 in FIGS. 1-5 or use other battery pack, as long as an air outlet of the battery pack 210 is corresponded with the tool main body 220.

The tool main body 220 has the same main structure as the tool main body 110 in the previous example. The tool main body 220 includes a tool housing 221, a first circuit board 222a, a second circuit board 222b, a switch 223, a main motor 224, a first fan 225 and a second fan 226.

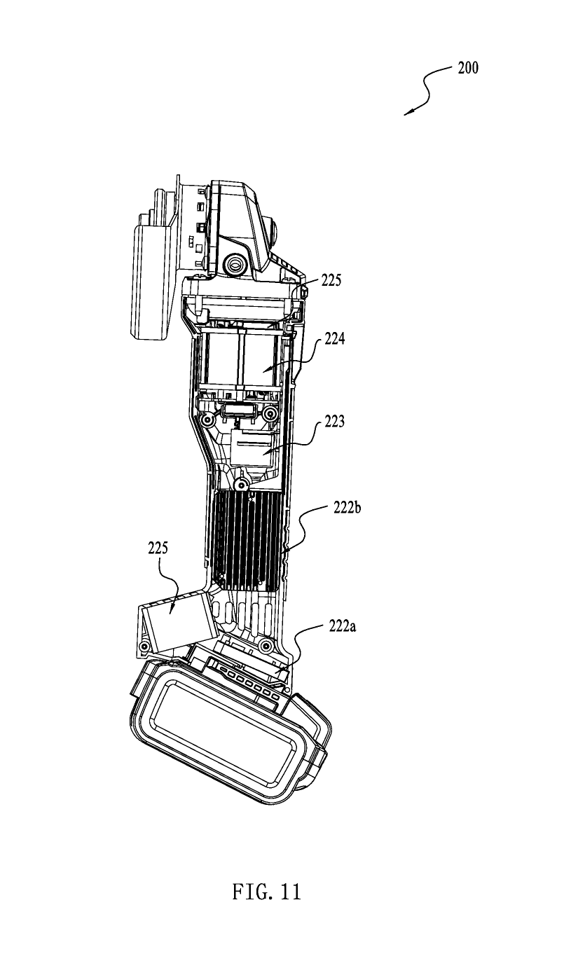

As shown in FIG. 11, the first circuit board 222a, the second circuit board 222b, the switch 223, the main motor 224 and the second fan 226 are contained in the tool housing 221 successively from the bottom up, which will not be illustrated again here.

The difference from the first described example is that the first fan 225 for generating airflow is disposed on the lower end of the tool housing 221. Specifically, the first fan 225 is disposed at a place of the lower end of the tool housing 221 which is opposite to an air outlet of the battery pack 210.

The tool main body 220 further includes an auxiliary motor. The auxiliary motor has an output shaft which is connected coaxially with the first fan 225 so as to drive the first fan 225 to rotate. It can be understood that, the auxiliary motor and the first fan 225 can be integrated into a whole. The battery pack 210 can supply power to the auxiliary motor, so that the auxiliary motor can drive the first fan 225 to rotate.

The tool housing 221 is formed with a tool air inlet 221a, a first air outlet 221b and a second air outlet 221c. The tool air inlet 221a is disposed on the front side and/or the rear side of the lower end of the tool housing 221 which is corresponded with the first circuit board 222a. The first air outlet 221b is disposed on the upper end of the tool housing 221 and located between a grinding element and the first fan 225. The tool air inlet 221a and the first air outlet 221b constitute a first airflow channel which allows the outside airflow entering the tool housing 221 through the tool air inlet 221a to exhaust from the tool housing 221 after passing the inside of the tool housing 221.

The second air outlet 221c is formed on a place of the lower end of the tool housing 221 that is corresponded with the first fan 225. The air inlet and the air outlet of the battery pack 120 and the second air outlet 221c of the tool housing 221 constitute a second airflow channel. The second air outlet 221c is disposed opposite to the air outlet of the battery pack 120. The airflow entering the battery pack 210 from the air inlet can flow in the battery pack 120 and flow out of the battery pack 120 through the second air outlet 221c under the action of the first fan 225.

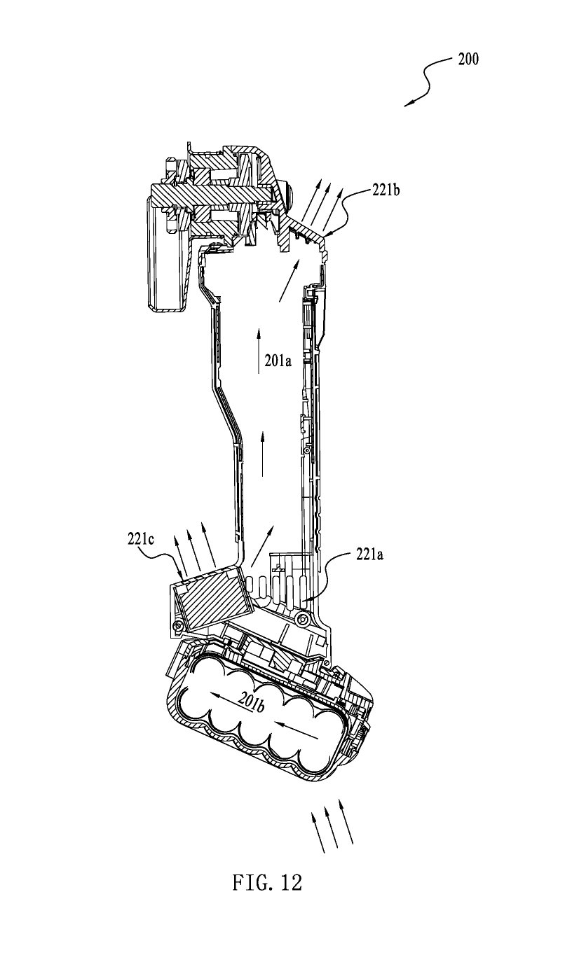

As shown in FIG. 12, when the angle grinder 200 is working, the outside airflow can flow into the tool housing 221 through the tool air inlet 221a and flow in the tool housing 221 along the arrow 201a so as to take away the heat generated by the first circuit board 222a, the second circuit board 222b, the switch 223 and the main motor 224, in turn, and finally flow out of the tool housing 221 through the first air outlet 221b so the requirement of heat dissipating of the tool main body 220 can be satisfied. The heat generated by the battery pack 210 can flow in the battery pack 210 along the arrow 201b under the action of the first fan 225 and then flow out through the second air outlet 221c.

With the example described above, the first airflow channel and the second airflow channel are independent from each other so as to avoid the heat generated by the battery pack 210 from affecting the circuit boards 222a, 222b and the switch 223 in the tool main body 220 so the reliability of the angle grinder 200 is improved. The first fan 225 is disposed above the air outlet of the battery pack 210 so as to accelerate the airflow in the battery pack 210 whereby the cooling efficiency of the battery pack 210 is further improved and the cooling efficiency of the whole angle grinder 200 is improved as well.

The first fan 225 also can be disposed between the air inlet and the air outlet of the battery pack 210. A motor can be disposed in the battery pack 210 for driving the first fan 225 to rotate. Specifically, the first fan 225 is a centrifugal fan.

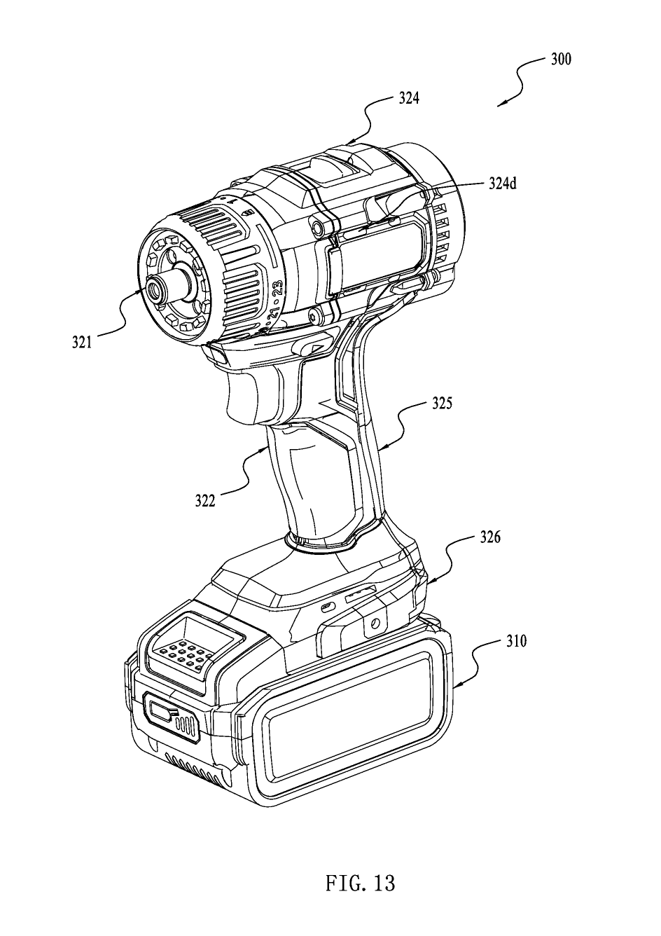

As shown in FIG. 13, an electric drill 300 includes a battery pack 310 and a tool main body 320.

The battery pack 310 can be coupled detachably with the tool main body 320 so as to supply power to the tool main body 320. Specifically, the battery pack 310 can be the same as the battery pack 120 in FIGS. 1-5 or use other battery pack as long as an air outlet of the battery pack 310 is corresponded with the tool main body 320.

The tool main body 320 includes a bit 321, a tool housing 322, a main motor 332, a first circuit board 331a, a second circuit board 331b, a trigger switch 341 and a first fan 351. The bit 321 is able to act on a workpiece so as to realize the drill function.

The tool housing 322 includes a containing portion 324 extending along a shaft of the main motor 332, a gripping portion 325 being substantially perpendicular to the containing portion 324 and a coupling portion 326 for coupling with the battery pack 310.

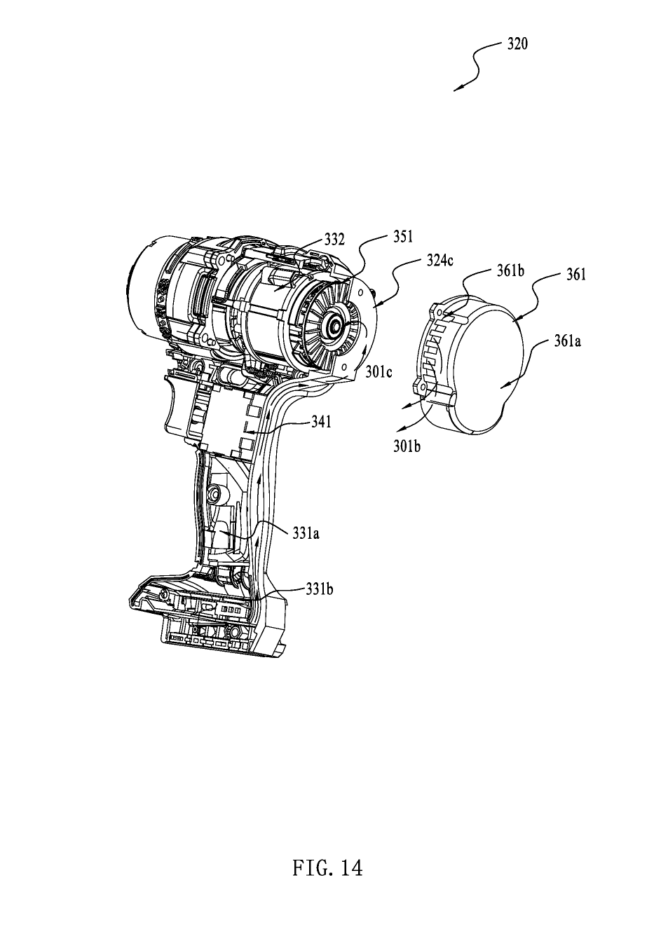

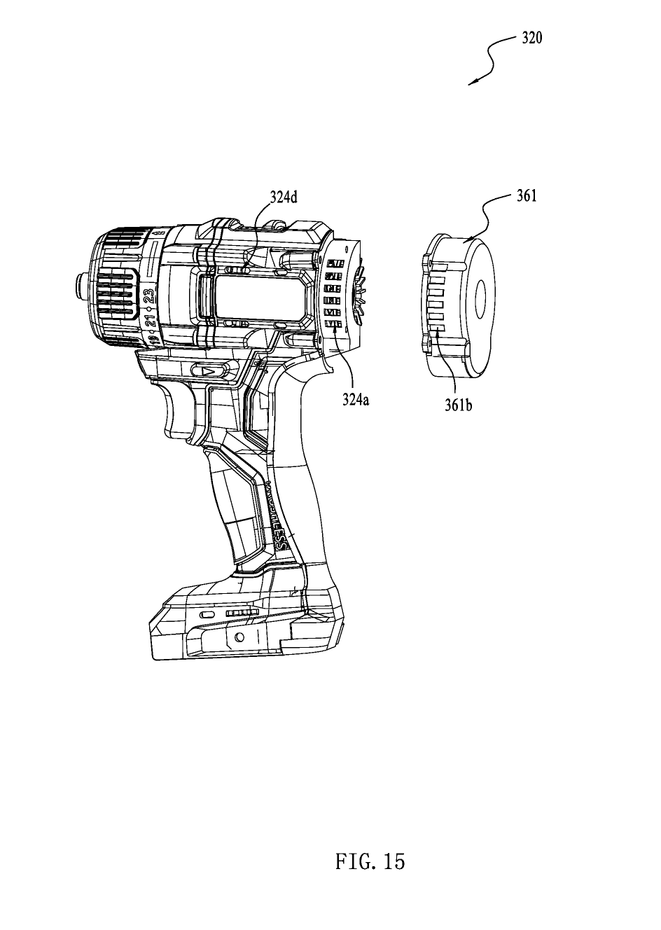

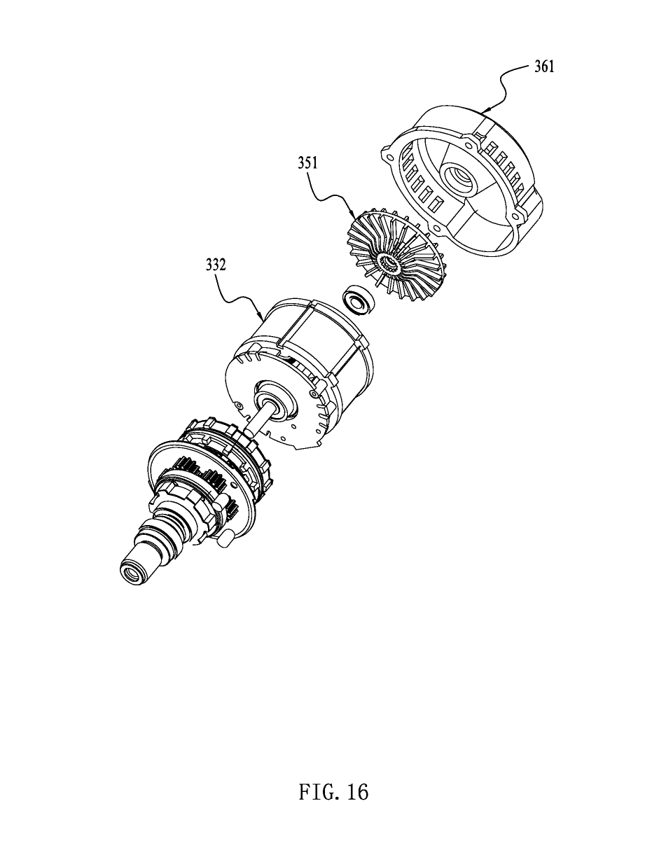

As shown in FIG. 14, the second circuit board 331b is disposed in the gripping portion 325. The trigger switch 341 is disposed on an end of the gripping portion 325 that is close to the containing portion 324, which is convenient for a user to grip. The trigger switch 341 acts as a starting and speed-control switch, which is used to turn on the electrical connection between the battery pack 310 and the tool main body 320 so that the electric drill 300 can be worked according to the operational instructions inputted by the user.

The tool main body 320 further includes a tool air channel 352 allowing the airflow to flow there through. Specifically, the tool air channel 352 is disposed on one side of the gripping portion 325 that is far from the trigger switch 341. The tool air channel 352 is extended in a length direction of the gripping portion 325 and forms a relatively independent flowing space. An end of the tool air channel 352 which is close to the battery pack 310 has an opening which is opposite to the air outlet of the battery pack 310.

Referring to FIGS. 14 and 15, the main motor 332 and the first fan 351 are disposed in the containing portion 324 along a length direction of the containing portion 324. The main motor 332 is located between the bit 321 and the first fan 351. The first fan 351 is disposed on one side of the containing portion 324 that is far from the bit 321 and connected coaxially with the main motor 332. The battery pack 310 can supply power to the main motor 332 so as to drive the first fan 351 to rotate.

The containing portion 324 is formed with a first air outlet 324a on its two sides in a radial direction of the first fan 351. In order to avoid the airflow flowing out of the first air outlet 324a from affecting the operation of the user, the first air outlet 324a is disposed on the front and rear sides of the containing portion 324. The containing portion 324 is formed with an air inlet 324d on two sides of the main motor 332. In the left and right direction, the air inlet 324d is located between the bit 321 and the first fan 351. In the front and rear direction, the air inlet 324d is disposed opposite to the main motor 332 so that the outside airflow entering the containing portion 324 can flow through the main motor 332.

The tool main body 320 further includes an air guide cover 361 for guiding the airflow. The air guide cover 361 is disposed on an end portion 324c of the containing portion 324 that is far from the bit 321. Specifically, the air guide cover 361 is formed with a containing recess so that a distance is formed between an end surface 361a of the air guide cover 361 and a plane on which the end portion 324c of the containing portion 324 is located in an axial direction of the shaft of the main motor 332 so the flow of the airflow is facilitated. The air guide cover 361 is also formed with a second air outlet 361b. When the air guide cover 361 is coupled with the containing portion 324 along the axial direction, the second air outlet 361b and the first air outlet 324a are opposite so that the airflow can exhaust.

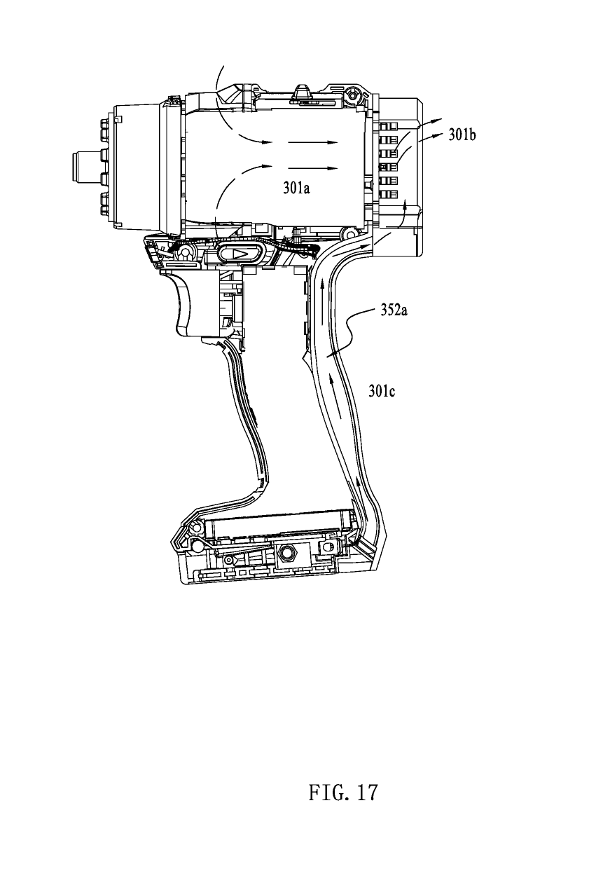

Specifically, the first fan 351 is a double-sided centrifugal fan. The first fan 351 can be driven by the main motor 332 so as to generate negative pressure on its two sides along the axial direction. As shown in FIG. 17, the negative pressure generated by the first fan 351 on the side close to the main motor 332 makes the airflow flow into the containing portion 324 through the air inlet 324d, and then flow through the main motor 332 along the arrow 301b, and finally flow out of the tool housing 332 through the first air outlet 324a and the second air outlet 361b along the arrow 310b. Referring to FIGS. 14 and 17, the negative pressure generated by the first fan 351 on the side far from to the main motor 332 makes the airflow from the battery pack 310 flow into the tool air channel 352, and then flow in the tool air channel 352 along the arrow 301c, and finally flow out of the tool housing 332 through the first air outlet 324a and the second air outlet 361b along the arrow 310b.

Thus, two independent air channels are formed in the electric drill 300 so as to reduce the influence on the circuit boards 331a, 331b and the trigger switch 341 in the tool main body 320 caused by the hot airflow of the battery pack 310 so the reliability of the electric drill 300 is improved. The dual-sided centrifugal fan can accelerate the airflow along the two independent air channels and save the inner space of the containing portion 324 effectively, so that the cooling property of the electric drill 300 is improved and the compactness of the whole structure is ensured.

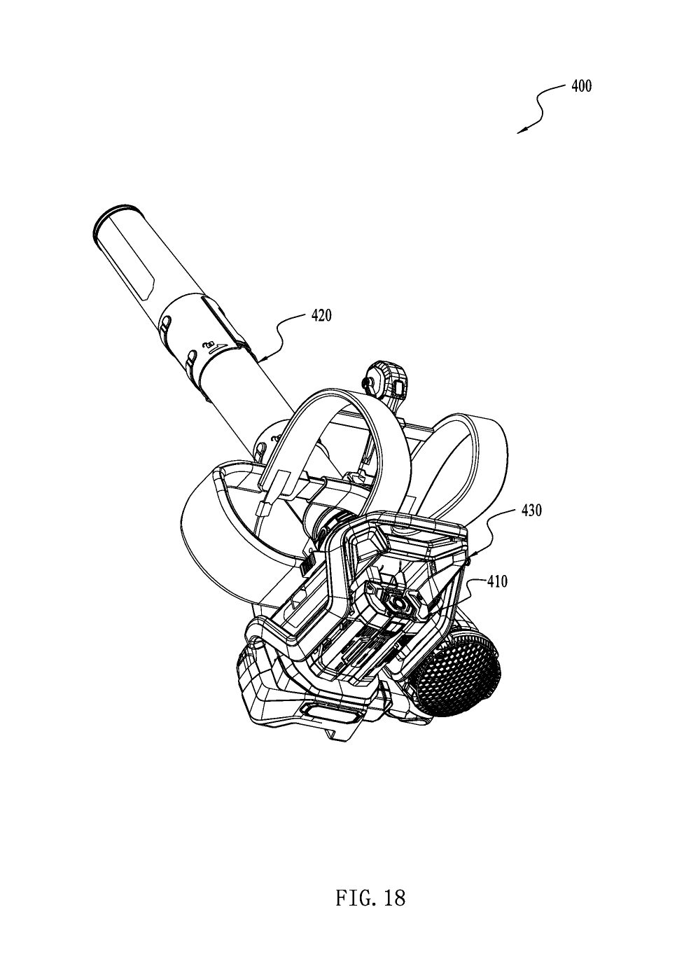

As shown in FIG. 18, a blower 400 includes a battery pack 410, a tool main body 420 and a backpack device 430. The tool main body 420 is connected with the backpack device 430. The battery pack 410 is connected detachably with the backpack device 430 for supplying power to the tool main body 420.

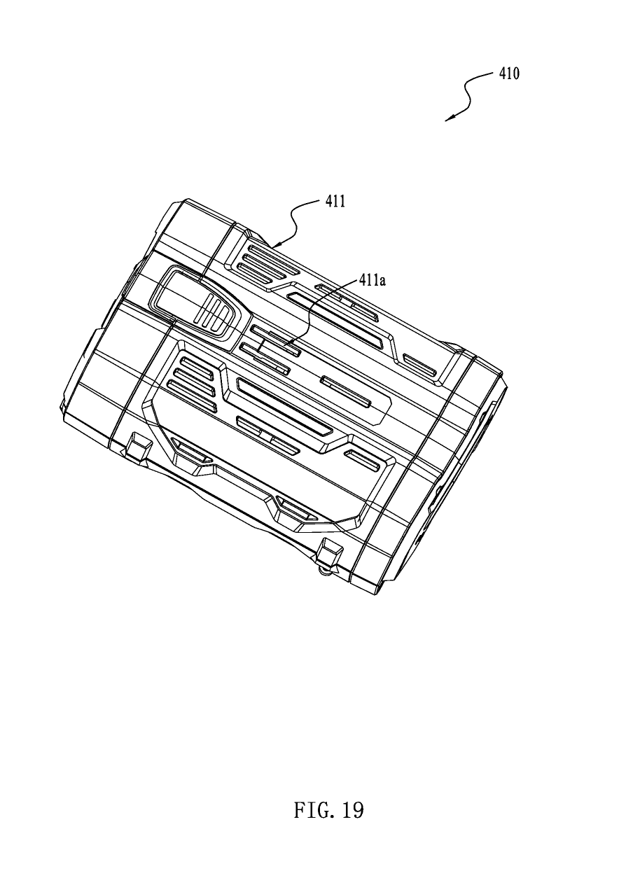

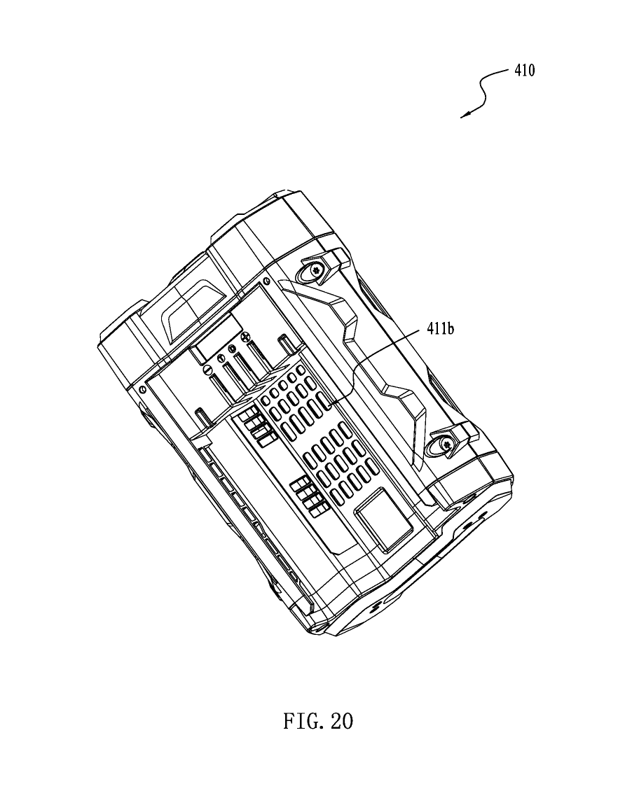

Referring to FIGS. 19-20, the battery pack 410 includes a battery housing 411 and a plurality of cells contained in the battery housing 411. In order to satisfy the requirement of large power of the blower 400, the battery pack 410 has an output voltage which is at least 56V. Because the battery pack 410 has large output voltage, it can generate a lot of heat while supplying power. So, the battery pack 410 is formed with an air inlet 411a and an air outlet 411b so as to form an airflow channel for cooling the battery pack 410.

Specifically, several air inlets 411a are disposed on one side of the battery housing 411 that is far from the human body, which allow the outside air to flow in. Several air outlets 411b are disposed on another side of the battery housing 411 that is connected with the backpack device 430. The outside air can enter the battery housing 411 through the air inlets 411a and exhaust through the air outlets 411b so as to take away the inner heat in the battery housing 411 and cool the battery pack 410. In order to ensure uniform cooling of the battery pack 410, the air inlets 411a have the same cooling area as the air outlets 411b approximately.

The tool main body 420 includes a tool attachment for realizing the blowing function of the blower 400 and a main motor for driving the tool attachment. Specifically, the tool attachment is an axial fan and the main motor is a motor which is able to drive the axial fan to rotate so as to generate airflow. The main structure of the tool main body 420 is the same as a common blower 400 approximately, which will not be illustrated here.

The backpack device 430 includes a device air channel 431 and a fan 432. The fan 432 is used to generate airflow. The device air channel 431 can be communicated with the air outlets 411b and the fan 432 when the battery pack 410 is coupled with the backpack device 430, so that the fan 432 can generate airflow for cooling the battery pack 410. The backpack device 430 further includes a controller for controlling a device motor to drive the fan 432 when the temperature of the battery pack 410 is greater than a predetermined value.

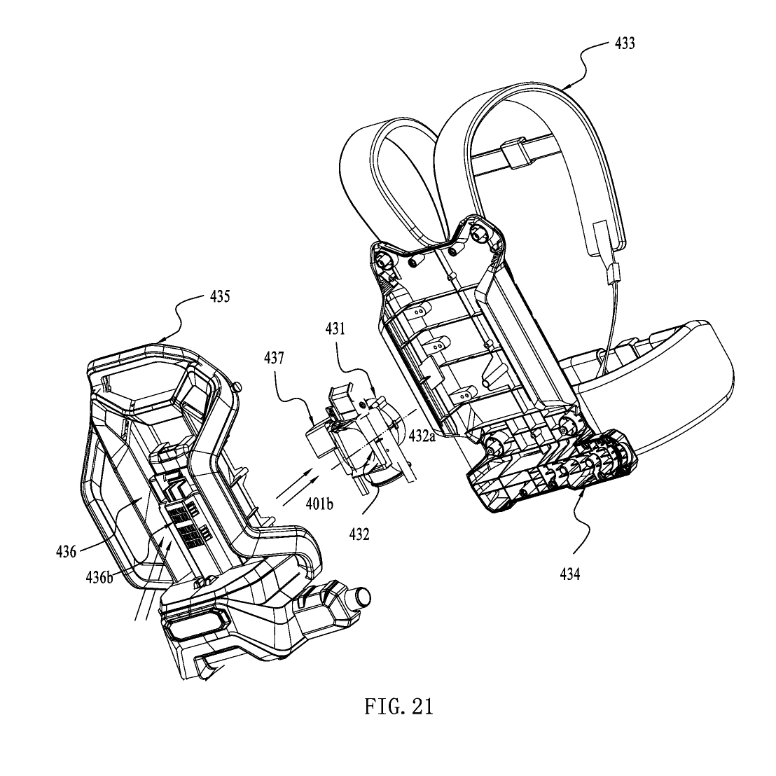

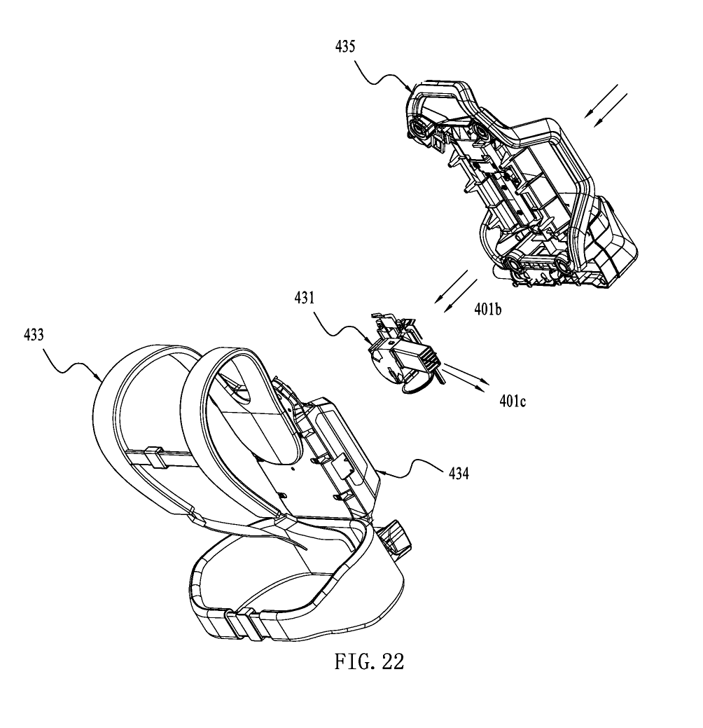

Referring to FIGS. 21-22, the backpack device 430 further includes a strap 433, a first housing 434 and a second housing 435. The first housing 434 is used to fix the strap 433, and the second housing 435 is used to place the battery pack 410. The first housing 434 and the second housing 435 are fixedly connected with each other so as to constitute an entire housing of the backpack device 430.

The second housing 435 includes a coupling portion 436 for coupling with the battery pack 410. The coupling portion 436 is formed with a coupling surface. The battery pack 410 can be coupled with the backpack device 430 along the coupling surface. Air flows in the direction 410b through vent openings 436b formed in coupling portion 436. The fan 432 is disposed between the first housing 434 and the second housing 435, which is able to rotate about a central axis 432a of itself. The central axis 432a is substantially perpendicular to the coupling surface. Specifically, the device air channel 431 is disposed opposite to the air outlets 411b of the battery pack 410 and extended along a direction of the central axis 432a. When the battery pack 410 is coupled with the backpack device 430, the device air channel 431 is communicated with the air outlets 411b of the battery pack 410 so as to cool the cells in the battery pack 410.

The backpack device 430 further includes an air guide cover 437 for guiding the airflow. The air guide cover 437 is formed with a containing chamber for containing the fan 432. That is, the air guide cover 437 is set outside the fan 432. An end of the air guide cover 437 allowing the air to enter is connected with the device air channel 431, and the other end is formed with a guide air outlet 437a for deflecting the airflow.

Referring to FIGS. 21-22, the tool main body 430 is supplied power by the battery pack 410. The outside air can flow into the battery pack 410 through the air inlets 411a and flow through the cells, and then flow out of the battery pack 410 through the air outlets 411b, and then flow into the air guide cover 437 along the arrow 401b under the action of the fan 432, and finally flow out through the guide air outlet 437a along the arrow 401c after being deflected by the air guide cover 437. The fan 432 and the air guide cover 437 are so arranged that the outside cool airflow flowing through the battery pack 410 is accelerated and it can take away more heat of the cells. So, the cooling efficiency of the battery pack 410 is improved. Meanwhile, the airflow can exhaust from the guide air outlet 437a located on one side of the fan 432. Thereby, it can avoid the hot airflow from affecting the elements in the tool housing, and meanwhile it can avoid the hot airflow from affecting the user. So, the user working with the backpack device can feel more comfortable.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. A battery pack, comprising:
a plurality of cells;
a housing for containing the cells; and
a pair of brackets for supporting the cells;
wherein each cell comprises:
a cell body for storing a chemical substance that is capable of generating electric energy; and
a pair of cell electrodes for allowing the cell to input or output the electric energy; and
wherein a sealant is filled between the brackets and the housing so that the cell electrodes are sealed in a sealed space constituted by the brackets, the housing, and the sealant, the cell body is partially located outside the sealed space, and the housing is formed with an air inlet and an air outlet so that an airflow through the air inlet and the air outlet can flow through a part of the cells which is located outside the sealed space.

2. The battery pack of claim 1, wherein the cell body is a generally cylindrical body taking a central axis as an axis, the cell electrodes are disposed on two ends of the cell body in a direction of the central axis, and the brackets support the two ends of the cell body respectively in the direction of the central axis.

3. The battery pack of claim 2, wherein the cell body has a length direction which is substantially parallel to the central axis.

4. The battery pack of claim 2, wherein the plurality of cells are arranged to be substantially parallel with each other.

5. The battery pack of claim 2, wherein the airflow flowing in through the air inlet and flowing out through the air outlet is substantially perpendicular to the cell body.

6. The battery pack of claim 2, wherein the housing comprises a cover disposed on the outside of an end of the cells in the direction of the central axis and the cover is coupled with the bracket so as to constitute the sealed space.

7. The battery pack of claim 6, wherein the cover is formed with a plurality of air holes which are corresponded with gaps between the cells.

8. The battery pack of claim 1, further comprises a fan for generating airflow and a battery motor for driving the fan to rotate wherein the fan is disposed between the air inlet and the air outlet.

9. A power tool, comprising:
a tool main body comprising a tool attachment for realizing a function of a tool and a main motor for driving the tool attachment; and
a battery pack which can be coupled detachably with the tool main body;
wherein the battery pack, comprises:
a plurality of cells;
a housing for containing the cells; and
a pair of brackets for supporting the cells;
wherein each cell comprises:
a cell body for storing a chemical substance that is capable of generating electric energy; and
a pair of cell electrodes for allowing the cell to input or output the electric energy; and
wherein a sealant is filled between the brackets and the housing so that the cell electrodes are sealed in a sealed space constituted by the brackets, the housing, and the sealant, the cell body is partially located outside the sealed space, and the housing is formed with an air inlet and an air outlet so that an airflow through the air inlet and the air outlet can flow through a part of the cells which is located outside the sealed space; and
wherein the tool main body comprises:
a first fan for generating airflow; and
a tool air channel which is capable of communicating the air outlet of the battery pack with the first fan when the battery pack is coupled with the tool main body, so that heat from the battery pack can flow in the tool air channel and dissipate heat under the action of the first fan.

10. The power tool of claim 9, wherein the first fan is driven by the main motor.

11. The power tool of claim 9, wherein the tool main body further comprises an auxiliary motor for driving the first fan.

12. The power tool of claim 9, wherein the tool main body further comprises a tool housing for containing the main motor and a second fan for exhausting the airflow from the tool housing wherein the second fan is disposed between the battery pack and the first fan.

13. A power tool, comprising:
a tool main body comprising a tool attachment for realizing a function of a tool and a main motor for driving the tool attachment; and
a battery pack comprising a housing and a plurality of cells contained in the housing;
a backpack device for wearing on a human body,
wherein the tool main body is connected with the backpack device, the battery pack is coupled detachably with the backpack device, the housing of the battery pack is formed with an air inlet and an air outlet, the backpack device comprises a device air channel, the device air channel is operable to communicate with the air outlet of the battery pack to cool the cells of the battery pack when the battery pack is coupled with the backpack device.

14. The power tool of claim 13, wherein the tool attachment of the tool main body is an axial fan.

15. The power tool of claim 13, wherein the main motor of the backpack device is supplied power by the battery pack.

16. The power tool of claim 13, wherein the backpack device comprises a controller for controlling the motor thereof to drive the fan when a temperature of the battery pack is greater than a predetermined value.

17. The power tool of claim 13, wherein the battery pack has an output voltage which is at least 56V.

18. A power tool, comprising:
a tool main body comprising a tool attachment for realizing a function of a tool and a main motor for driving the tool attachment; and
a battery pack comprising a housing and a plurality of cells contained in the housing, the housing comprising an air outlet;
wherein the tool main body comprises a first fan for generating airflow and a tool air channel which is capable of communicating the air outlet of the battery pack and the first fan when the battery pack is coupled with the tool main body, so that heat from the battery pack can flow in the tool air channel and dissipate heat under the action of the first fan.

19. The power tool of claim 18, wherein the first fan is driven by the main motor.

20. The power tool of claim 18, wherein the tool main body further comprises a tool housing for containing the main motor and a second fan for exhausting airflow from the tool housing wherein the second fan is disposed between the battery pack and the first fan.
